(19) United States
(12) Patent Application Publication
(10) Pub. No.: US 2026/0231056 A1
(43) Pub. Date: Aug. 6, 2026

(54) READER TO DEVICE COMMUNICATION WITH REPETITION

(71) Applicant: QUALCOMM Incorporated, San Diego, CA (US)

(72) Inventors: Ahmed Abdelaziz Ibrahim Abdelaziz ZEWAIL, San Diego, CA (US); Yuchul KIM, San Diego, CA (US); Zhifei FAN, San Diego, CA (US); Chengjin ZHANG, San Diego, CA (US)

(21) Appl. No.: 19/042,662

(22) Filed: Jan. 31, 2025

(51) Int. Cl. H04W 56/00; H04L 1/1607; H04L 1/18

(52) U.S. Cl. CPC H04W 56/001; H04L 1/1607; H04L 1/18

(57) ABSTRACT

Methods, systems, and devices for wireless communications are described, including communications involving ambient power wireless communication devices such as ambient internet of things (A-IoT) devices. A reader to device (R2D) communication may begin with a start indicator part (SIP) signal followed by a clock acquisition part (CAP) signal, followed by a control part and a data part. To enhance decoding of the R2D communication, block repetitions may be used. A synchronization signal (such as a CAP or a repetition start part signal) may be included in the R2D communication for each data part (e.g., for each repetition of the data part). Accordingly, the ambient power wireless communication device may resynchronize timing with the reader device for each repetition of the data part, thereby increasing the decoding accuracy of the data part.

### FIELD OF TECHNOLOGY

The following relates to wireless communications, including reader to device communication with repetition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an ambient power wireless communication device is described. The method may include receiving, from a reader device, a start indicator part (SIP) signal of a reader to device (R2D) communication, the SIP signal indicating a beginning of the R2D communication and indicating for the ambient power wireless communication device to monitor for one or more data part repetitions of the R2D communication, receiving a first synchronization signal of the R2D communication based on the SIP signal, monitoring for a first repetition of a data part of the R2D communication based on the first synchronization signal, receiving a second synchronization signal of the R2D communication associated with a second repetition of the data part, monitoring for the second repetition of the data part based on the second synchronization signal, and decoding the data part based on monitoring for the first repetition, the second repetition, or both.

An apparatus for wireless communications at an ambient power wireless communication device is described. The apparatus may include one or more processors, and instructions stored in one or more memories and executable by the one or more processors, individually or collectively, to cause the apparatus to receive, from a reader device, a SIP signal of a R2D communication, the SIP signal indicating a beginning of the R2D communication and indicating for the ambient power wireless communication device to monitor for one or more data part repetitions of the R2D communication, receive a first synchronization signal of the R2D communication based on the SIP signal, monitor for a first repetition of a data part of the R2D communication based on the first synchronization signal, receive a second synchronization signal of the R2D communication associated with a second repetition of the data part, monitor for the second repetition of the data part based on the second synchronization signal, and decode the data part based on monitoring for the first repetition, the second repetition, or both.

Another ambient power wireless communication device for wireless communications is described. The ambient power wireless communication device may include means for receiving, from a reader device, a SIP signal of a R2D communication, the SIP signal indicating a beginning of the R2D communication and indicating for the ambient power wireless communication device to monitor for one or more data part repetitions of the R2D communication, means for receiving a first synchronization signal of the R2D communication based on the SIP signal, means for monitoring for a first repetition of a data part of the R2D communication based on the first synchronization signal, means for receiving a second synchronization signal of the R2D communication associated with a second repetition of the data part, means for monitoring for the second repetition of the data part based on the second synchronization signal, and means for decoding the data part based on monitoring for the first repetition, the second repetition, or both.

A non-transitory computer-readable medium storing code for wireless communications is described. The code may include instructions executable by one or more processors to receive, from a reader device, a SIP signal of a R2D communication, the SIP signal indicating a beginning of the R2D communication and indicating for the ambient power wireless communication device to monitor for one or more data part repetitions of the R2D communication, receive a first synchronization signal of the R2D communication based on the SIP signal, monitor for a first repetition of a data part of the R2D communication based on the first synchronization signal, receive a second synchronization signal of the R2D communication associated with a second repetition of the data part, monitor for the second repetition of the data part based on the second synchronization signal, and decode the data part based on monitoring for the first repetition, the second repetition, or both.

In some examples of the method, apparatus, ambient power wireless communication devices, and non-transitory computer-readable medium described herein, the first synchronization signal may be a first clock acquisition part (CAP) signal and the second synchronization signal may be a second CAP signal.

In some examples of the method, apparatus, ambient power wireless communication devices, and non-transitory computer-readable medium described herein, the first synchronization signal may be a first CAP signal having a first sequence type and the second synchronization signal may be a repetition start part signal having a second sequence type different than the first sequence type.

Some examples of the method, apparatus, ambient power wireless communication devices, and non-transitory computer-readable medium described herein may further include operations, features, means, or instructions for receiving, after the second synchronization signal and prior to the second repetition, a second CAP signal having the first sequence type.

Some examples of the method, apparatus, ambient power wireless communication devices, and non-transitory computer-readable medium described herein may further include operations, features, means, or instructions for receiving a control part of the R2D communication prior to the first repetition and based on the first synchronization signal.

In some examples of the method, apparatus, ambient power wireless communication devices, and non-transitory computer-readable medium described herein, the first synchronization signal indicates a first quantity of chips per orthogonal frequency-division multiplexing (OFDM) symbol associated with the control part and the control part indicates a second quantity of chips per OFDM symbol associated with the first repetition.

In some examples of the method, apparatus, ambient power wireless communication devices, and non-transitory computer-readable medium described herein, the second synchronization signal indicates a third quantity of chips per OFDM symbol associated with the second repetition.

Some examples of the method, apparatus, ambient power wireless communication devices, and non-transitory computer-readable medium described herein may further include operations, features, means, or instructions for receiving a second control part of the R2D communication prior to the second repetition and based on the second synchronization signal.

Some examples of the method, apparatus, ambient power wireless communication devices, and non-transitory computer-readable medium described herein may further include operations, features, means, or instructions for transmitting a device to reader communication based on scheduling information included in the control part.

In some examples of the method, apparatus, ambient power wireless communication devices, and non-transitory computer-readable medium described herein, the second synchronization signal may have a different duration than the first synchronization signal.

Some examples of the method, apparatus, ambient power wireless communication devices, and non-transitory computer-readable medium described herein may further include operations, features, means, or instructions for receiving a third synchronization signal of the R2D communication associated with a third repetition of the data part and monitoring for the third repetition of the data part based on the third synchronization signal.

In some examples of the method, apparatus, ambient power wireless communication devices, and non-transitory computer-readable medium described herein, a first quantity of chips per OFDM symbol associated with the first repetition may be higher than a second quantity of chips per OFDM symbol associated with the second repetition.

A method for wireless communications by a reader device is described. The method may include transmitting, to an ambient power wireless communication device, a SIP signal of a R2D communication, the SIP signal indicating a beginning of the R2D communication and indicating for the ambient power wireless communication device to monitor for one or more data part repetitions of the R2D communication, transmitting a first synchronization signal of the R2D communication based on the SIP signal, transmitting a first repetition of a data part of the R2D communication based on the first synchronization signal, transmitting a second synchronization signal of the R2D communication associated with a second repetition of the data part, and transmitting the second repetition of the data part based on the second synchronization signal.

An apparatus for wireless communications at a reader device is described. The apparatus may include one or more processors, and instructions stored in one or more memories and executable by the one or more processors, individually or collectively, to cause the apparatus to transmit, to an ambient power wireless communication device, a SIP signal of a R2D communication, the SIP signal indicating a beginning of the R2D communication and indicating for the ambient power wireless communication device to monitor for one or more data part repetitions of the R2D communication, transmit a first synchronization signal of the R2D communication based on the SIP signal, transmit a first repetition of a data part of the R2D communication based on the first synchronization signal, transmit a second synchronization signal of the R2D communication associated with a second repetition of the data part, and transmit the second repetition of the data part based on the second synchronization signal.

Another reader device for wireless communications is described. The reader device may include means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication, means for transmitting a first synchronization signal of the R2D communication based on the SIP signal, means for transmitting a first repetition of a data part of the R2D communication based on the first synchronization signal, means for transmitting a second synchronization signal of the R2D communication associated with a second repetition of the data part, and means for transmitting the second repetition of the data part based on the second synchronization signal.

A non-transitory computer-readable medium storing code for wireless communications is described. The code may include instructions executable by one or more processors to transmit, to an ambient power wireless communication device, a SIP signal of a R2D communication, the SIP signal indicating a beginning of the R2D communication and indicating for the ambient power wireless communication device to monitor for one or more data part repetitions of the R2D communication, transmit a first synchronization signal of the R2D communication based on the SIP signal, transmit a first repetition of a data part of the R2D communication based on the first synchronization signal, transmit a second synchronization signal of the R2D communication associated with a second repetition of the data part, and transmit the second repetition of the data part based on the second synchronization signal.

In some examples of the method, apparatus, reader devices, and non-transitory computer-readable medium described herein, the first synchronization signal may be a first CAP signal and the second synchronization signal may be a second CAP signal.

In some examples of the method, apparatus, reader devices, and non-transitory computer-readable medium described herein, the first synchronization signal may be a first CAP signal having a first sequence type and the second synchronization signal may be a repetition start part signal having a second sequence type different than the first sequence type.

Some examples of the method, apparatus, reader devices, and non-transitory computer-readable medium described herein may further include operations, features, means, or instructions for transmitting, after the second synchronization signal and prior to the second repetition, a second CAP signal having the first sequence type.

Some examples of the method, apparatus, reader devices, and non-transitory computer-readable medium described herein may further include operations, features, means, or instructions for transmitting a control part of the R2D communication prior to the first repetition and based on the first synchronization signal.

In some examples of the method, apparatus, reader devices, and non-transitory computer-readable medium described herein, the first synchronization signal indicates a first quantity of chips per OFDM symbol associated with the control part and the control part indicates a second quantity of chips per OFDM symbol associated with the first repetition.

In some examples of the method, apparatus, reader devices, and non-transitory computer-readable medium described herein, the second synchronization signal indicates a third quantity of chips per OFDM symbol associated with the second repetition.

Some examples of the method, apparatus, reader devices, and non-transitory computer-readable medium described herein may further include operations, features, means, or instructions for transmitting a second control part of the R2D communication prior to the second repetition and based on the second synchronization signal.

Some examples of the method, apparatus, reader devices, and non-transitory computer-readable medium described herein may further include operations, features, means, or instructions for receiving, from the ambient power wireless communication device, a device to reader communication based on scheduling information included in the control part.

In some examples of the method, apparatus, reader devices, and non-transitory computer-readable medium described herein, the second synchronization signal may have a different duration than the first synchronization signal.

Some examples of the method, apparatus, reader devices, and non-transitory computer-readable medium described herein may further include operations, features, means, or instructions for transmitting a third synchronization signal of the R2D communication and transmitting a third repetition of the data part based on the third synchronization signal.

In some examples of the method, apparatus, reader devices, and non-transitory computer-readable medium described herein, a first quantity of chips per OFDM symbol associated with the first repetition may be higher than a second quantity of chips per OFDM symbol associated with the second repetition.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports reader to device (R2D) signal with repetition in accordance with one or more aspects of the present disclosure.

FIG. 2 shows an example of a wireless communications system that supports R2D communication with repetition in accordance with one or more aspects of the present disclosure.

FIG. 3 shows an example of a timing diagram that supports R2D communication with repetition in accordance with one or more aspects of the present disclosure.

FIG. 4 shows an example of a timing diagram that supports R2D communication with repetition in accordance with one or more aspects of the present disclosure.

FIG. 5 shows an example of a timing diagram that supports R2D communication with repetition in accordance with one or more aspects of the present disclosure.

FIG. 6 shows an example of a timing diagram that supports R2D communication with repetition in accordance with one or more aspects of the present disclosure.

FIG. 7 shows an example of a timing diagram that supports R2D communication with repetition in accordance with one or more aspects of the present disclosure.

FIG. 8 shows an example of a process flow that supports R2D communication with repetition in accordance with one or more aspects of the present disclosure.

FIGS. 9 and 10 show block diagrams of devices that support R2D communication with repetition in accordance with one or more aspects of the present disclosure.

FIG. 11 shows a block diagram of a communications manager that supports R2D communication with repetition in accordance with one or more aspects of the present disclosure.

FIG. 12 shows a diagram of a system including a device that supports R2D communication with repetition in accordance with one or more aspects of the present disclosure.

FIGS. 13 and 14 show block diagrams of devices that support R2D communication with repetition in accordance with one or more aspects of the present disclosure.

FIG. 15 shows a block diagram of a communications manager that supports R2D communication with repetition in accordance with one or more aspects of the present disclosure.

FIG. 16 shows a diagram of a system including a device that supports R2D communication with repetition in accordance with one or more aspects of the present disclosure.

FIGS. 17 and 18 show flowcharts illustrating methods that support R2D communication with repetition in accordance with one or more aspects of the present disclosure.

### DETAILED DESCRIPTION

Some wireless communications systems may support ambient power wireless communication devices, such as ambient internet of things (A-IoT) devices. Ambient power wireless communication devices may refer to a class of low-complexity devices (e.g., tags, sensors) which may harvest energy from ambient signaling (e.g., incident radio frequency sources) from reader devices and/or may backscatter incident signals or carrier waves to send data to reader devices. In some examples, the reader device may be included in a network entity or in a user equipment (UE). In some wireless communications systems, communication between an ambient power wireless communication device and a reader device may be modulated using on-off-keying (OOK) modulation. A chip rate, or M, may refer to the quantity of chips (e.g., the quantity of possible states represented by the OOK modulation) per orthogonal frequency division multiplexing (OFDM) symbol.

A reader to device (R2D) communication may begin with a start indicator part (SIP) signal followed by a clock acquisition part (CAP) signal, followed by a control part and a data part. In some examples, ambient power wireless communication devices may experience error in the local clock of the ambient power wireless communication devices based on such low-cost technologies (e.g., some devices may not be equipped with a crystal clock). Thus, the CAP signal may be used to synchronize timing with the reader device and/or to determine the value of M for the control part and/or the data part. To enhance decoding of the R2D communication (also referred to as an R2D signal), block repetitions may be used. For example, multiple repetitions of the data part may be included within an R2D communication. Due to the low-complexity of ambient power wireless communication devices, the clock of an ambient power wireless communication device may shift during the multiple repetitions within an R2D communication, and thus clock error may decrease the decoding accuracy of the ambient power wireless communication device for later repetitions of data.

Aspects of this disclosure relate to the inclusion of a synchronization signal for each repetition of a data part in an R2D communication. Accordingly, the ambient power wireless communication device may resynchronize timing with the reader device for each repetition of a data part, thereby increasing the decoding accuracy of the data part. For example, an R2D communication may include a CAP signal for each repetition of the data part of the R2D communication. In some examples, a first CAP signal may indicate the value of M for the control part, and the control part may indicate the value of M for the first repetition of the data part (e.g., for the first data part). Accordingly, the data and control parts may use different values of M. In some examples, subsequent repetitions of the data part may include smaller values of M in order to increase the probability of successfully decoding the subsequent repetitions of the data part. In some examples, a different type of signal than a CAP signal may be used to indicate the start of a subsequent repetition of data. For example, a repetition start part indicator signal may use a different sequence type than a CAP signal, and thus the ambient power wireless communication device may detect the start of a subsequent repetition based on the reception of a signal having a different sequence type.

Aspects of the disclosure are initially described in the context of wireless communications systems. Aspects of the disclosure are further illustrated by and described with reference to timing diagrams, process flows, apparatus diagrams, system diagrams, and flowcharts that relate to R2D communication with repetition.

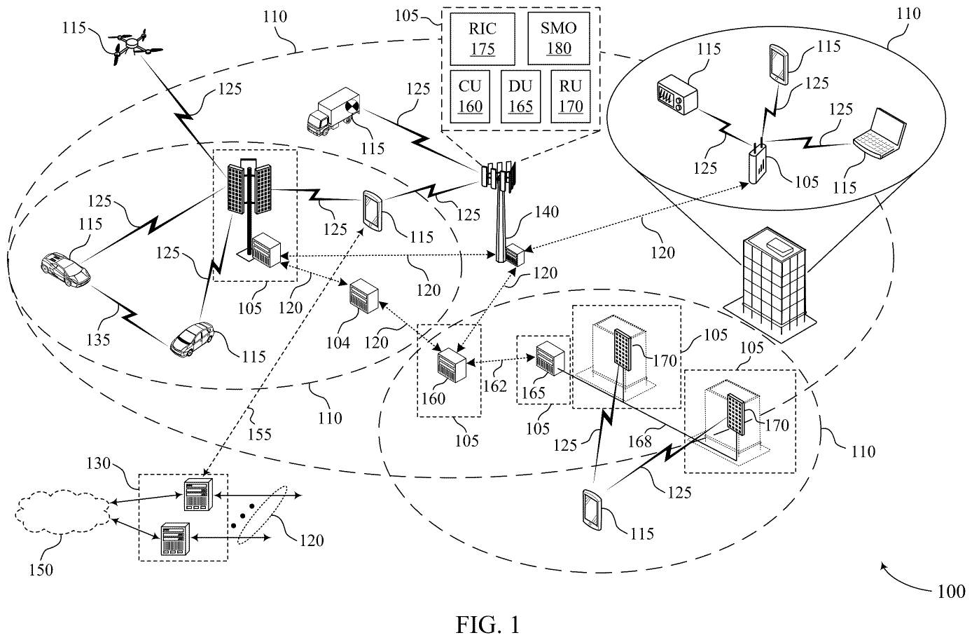

FIG. 1 shows an example of a wireless communications system 100 that supports R2D communication with repetition in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support R2D communication with repetition as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support communications involving one or more ambient power wireless communication devices. For example, an ambient power wireless communication device may be a UE 115 which may harvest energy from ambient signaling and/or may use backscattering to communicate with a reader device. For example, an ambient power wireless communication device may be an A-IoT device or a radio frequency identification (RFID) tag. In some examples, a reader device may be a network entity 105 or a UE 115 as described herein. For example, in a first topology, a reader device may be a network entity 105 which communicates with an ambient power wireless communication device (e.g., in environments such as warehouses, factories, or retail stores for use cases such as inventory tracking, sensing, or provision of commands to equipment). For example, the first topology may provide continuous indoor coverage for ambient power wireless communication devices within an environment. In the first topology, a central control unit may operate as a single controller to schedule and coordinate multiple reader devices. Reader devices or nodes may be low cost and may be coordinated by the central control unit. The reader devices may be positioned at an inter-site distance (ISD) of 20 to 30 meters (m) of each other. Passive tags (ambient power wireless communication devices without a battery or energy storage capability) may have comparable costs to RFID tags. In some examples, the first topology may enable longer ranges than RFID (e.g., the first topology may support 20-30 m non-line of sight (NLOS) communications). For example, a forward link enhancement to increase range may include the use of a licensed band (sub 1 GHz) to enable higher reader transmission power (e.g., at 36-42 decibel-milliwatts (dBm) equivalent isotropic radiated power (EIRP)). Another forward link enhancement to increase range may include multi-point energizing to combine gain (e.g., 4 devices may transmit energizing signals to an ambient power wireless communication device which the ambient power wireless communication device may use to harvest energy or backscatter). In some examples, ambient power wireless communication devices such as A-IoT devices may have increased sensitivity as compared to RFID tags (e.g., 6-8 dB better). As another example, a backward link enhancement to increase range may include bistatic transmission to reduce self-interference from the carrier wave (e.g., receiving a carrier wave from one reader device or energizing device and communicating with a different reader device using the energy from the carrier wave), which may improve the reader device receive sensitivity for a device to reader (D2R) signal by 15 dB. As another example, a backward link enhancement to increase range may include channel coding, which may provide a 4 dB coding gain over RFID.

As another example, in a second topology, a reader device may be a UE 115 (such as a handheld device) which may communicate with an ambient power wireless communication device (e.g., for scanning of ambient power wireless communication devices with a handheld reader device in environments such as warehouses, factories, retail stores, or consumer homes and for use cases such as inventory tracking, sensing, or provision of commands to equipment).

As described herein, to communicate with an ambient power wireless communication device, a reader device may send an R2D communication to the ambient power wireless communication device. The R2D communication may start with an SIP signal followed by a CAP signal. The CAP signal may be used by the ambient power wireless communication device for estimating the quantity of chip per symbol and the value of M for OOK-4, for the data query of the R2D communication (e.g., for the data part of the R2D signal). To enhance the decoding accuracy of the ambient power wireless communication device, block repetition may be implemented in the R2D communication (e.g., the data part or query in the R2D communication may be transmitted multiple times). For example, at 1% block error ratio, use of repetitions for R2D communications may provide a 2 dB gain. An ambient power wireless communication device may not be expected to perform soft-combining on the repetitions. For example, the ambient power wireless communication device may decode each repetition of the data part independently (e.g., when a CRC is successful for a repetition of the data part, the ambient power wireless communication device may terminate decoding subsequent repetitions). As described herein, due to the low-complexity of ambient power wireless communication devices, the clock of an ambient power wireless communication device may shift during the multiple repetitions within an R2D communication, and thus clock error may decrease the decoding accuracy of the ambient power wireless communication device for later repetitions of the data part. Further, the clock error of an ambient power wireless communication device may increase the difficulty of determining the end of a given repetition within an R2D communication for an ambient power wireless communication device, which may lead to decoding error.

In some examples, a synchronization signal may be included in an R2D communication for each repetition of the data part. Accordingly, the ambient power wireless communication device may resynchronize timing with the reader device for each repetition of the data part, thereby increasing the decoding accuracy, For example, an R2D communication may include a CAP signal (also referred to as a CAP) for each repetition of the data part of the R2D communication. In some examples, a first CAP may indicate the value of M for the control part, and the control part may indicate the value of M for the first repetition of data. Accordingly, the data and control parts may use different values of M. In some examples, subsequent repetitions of data may include smaller values of M in order to increase the probability of successfully decoding the subsequent repetitions of data. In some examples, a different type of signal than a CAP may be used to indicate the start of a subsequent repetition of data. For example, a repetition start part indicator signal may use a different sequence type than a CAP, and thus the ambient power wireless communication device may detect the start of a subsequent repetition based on the reception of a signal having a different sequence type.

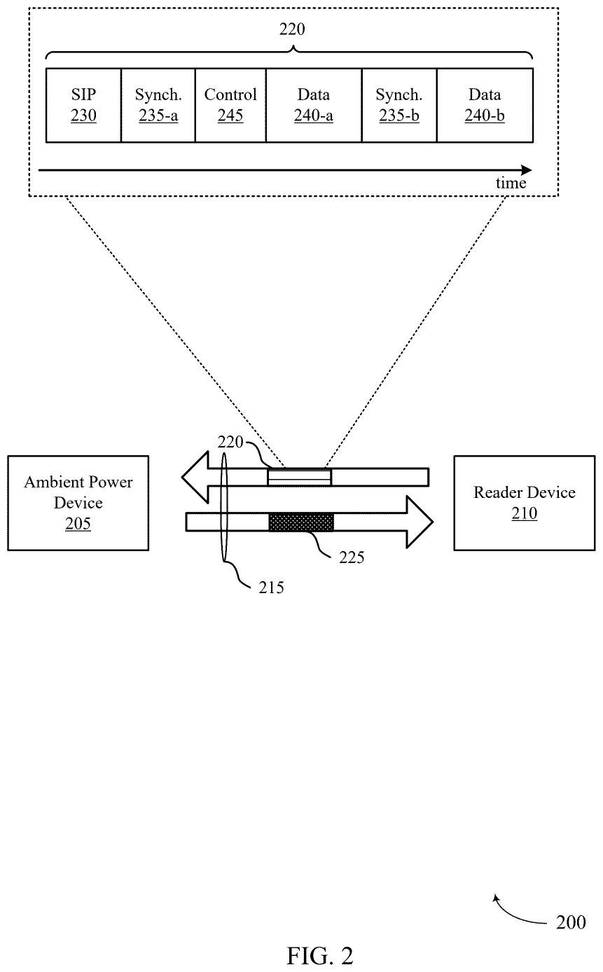

FIG. 2 shows an example of a wireless communications system 200 that supports R2D communication with repetition in accordance with one or more aspects of the present disclosure. The wireless communications system 200 may implement or may be implemented by aspects of the wireless communications system 100. For example, the wireless communications system 200 may include an ambient power wireless communication device 205, which may be an example of a UE 115 as described herein. As another example, the wireless communications system 200 may include a reader device 210, which may be an example of a UE 115 or a network entity 105 as described herein. The reader device 210 and the ambient power wireless communication device 205 may communicate via a communication link 215, which may include a forward link (e.g., an R2D link) and a backward link (e.g., a D2R link). In some examples, the communication link 125 may be an example of a communication link 125 as described herein (e.g., where the reader device 210 is a network entity 105) or a D2D communication link 135 (e.g., where the reader device 210 is a UE 115).

In some examples, the reader device 210 may transmit an R2D communication 220 to the ambient power wireless communication device 205 via the communication link 215. The R2D communication 220 may implement block repetition of data parts 240 to increase the decoding accuracy of the data parts 240. For example, the R2D communication 220 may include an SIP signal 230, and a synchronization signal 235 for each data part 240, which may enable the ambient power wireless communication device to synchronize timing with the reader device 210 for each data part 240. For example, the R2D communication 220 may include a first synchronization signal 235-a prior to the first data part 240-a and a second synchronization signal 235-b prior to the second data part 240-b. As described herein, the second data part 240-b may be a repetition of (e.g., may include the same data as) the first data part 240-a to increase the probability the ambient power wireless communication device 205 successfully decodes at least one of the data parts 240. Accordingly, the first data part 240-a may also be referred to as a first repetition of the data part, and the second data part 240-b may also be referred to as a second repetition of the data part. In some examples, if the ambient power wireless communication device 205 successfully decodes the first data part 240-a, the ambient power wireless communication device 205 may skip monitoring for and/or decoding the second data part 240-b.

In some examples, the data part 240 or a control part 245 of the R2D communication 220 may include scheduling information for a D2R signal 225. For example, the ambient power wireless communication device 205 may provide a D2R signal 225 in response to the R2D communication 220 (e.g., which may provide data from the ambient power wireless communication device 205 to the reader device 210). In passive A-IoT scenarios, the D2R signal 225 may be a backscatter signal in response to a carrier wave provided by the reader device 210 or another energizing device (e.g., in a bistatic scenario). In active or semi-passive scenarios where the ambient power wireless communication device 205 has energy storage capabilities (e.g., includes a battery) or active signal generation capabilities (e.g., has a power source), the D2R signal 225 may be an active signal generated by the ambient power wireless communication device 205 (e.g., may not be a backscatter signal). In some examples, the R2D communication 220 may be a query, such as for information (e.g., inventory information or sensor information), which may be provided by the ambient power wireless communication device 205 in the R2D communication 220. For example, the R2D communication 220 may provide scheduling information for a D2R signal and the ambient power wireless communication device 205 may send a D2R signal 225 in accordance with the scheduling information, where the D2R signal 225 may include the queried/requested information from the ambient power wireless communication device 205. In some examples, the R2D communication 220 may be a command (e.g., may provide command information to the ambient power wireless communication device 205 to perform an action or to cause a connected device to perform an action).

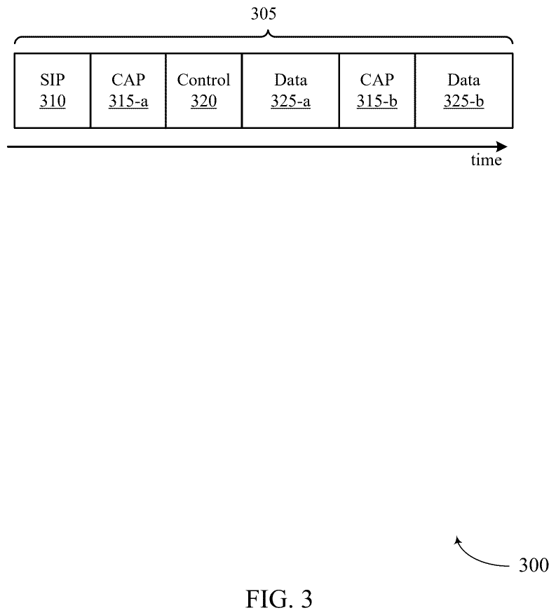

FIG. 3 shows an example of a timing diagram 300 that supports R2D communication with repetition in accordance with one or more aspects of the present disclosure. The timing diagram 300 may implement or may be implemented by aspects of the wireless communications system 100 or the wireless communications system 200. For example, the timing diagram 300 shows an example format of an R2D communication 305, which may be an example of an R2D communication 220 as described herein.

In some examples, where the R2D communication 305 implements block repetition of data parts 325 (e.g., which may correspond to the data parts 240 as described with reference to FIG. 2), the R2D communication 305 may include a CAP 315 for each data part 325. For example, the CAPs 315 may correspond to the synchronization signals 235 as described with reference to FIG. 2.

For example, as shown in the timing diagram 300, the R2D communication 305 may include a SIP signal 310, a first CAP 315-a, a control part 320, a first data part 325-a, a second CAP 315-b, and a second data part 325-b. The SIP signal 310 may indicate to an ambient power wireless communication device the beginning of the R2D communication 305. In some examples, an ambient power wireless communication device that receives the R2D communication 305 may use each CAP 315 to refine the estimate of the quantity of samples per chip. In some examples, each CAP 315 may define the start of each repetition. For example, the ambient power wireless communication device that receives the SIP signal 310 may turn on a searcher module or searcher circuitry to search for the CAP sequence to define the start of each repetition. As an example, the first CAP 315-a may indicate to the ambient power wireless communication device to monitor for the control part 320 and/or the first data part 325-a, and the second CAP 315-b may indicate to the ambient power wireless communication device to monitor for the second data part 325-b.

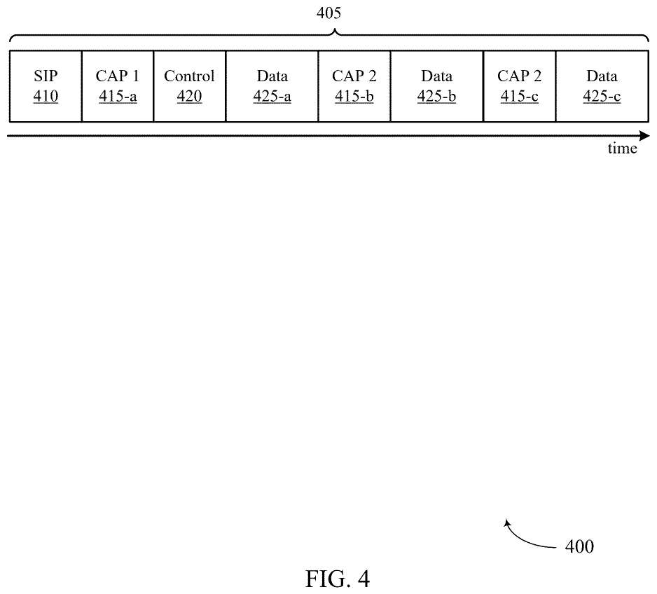

FIG. 4 shows an example of a timing diagram 400 that supports R2D communication with repetition in accordance with one or more aspects of the present disclosure. The timing diagram 400 may implement or may be implemented by aspects of the wireless communications system 100 or the wireless communications system 200. For example, the timing diagram 400 shows an example format of an R2D communication 405, which may be an example of an R2D communication 220 as described herein.

In some examples, where the R2D communication 405 implements block repetition of data parts 425 (e.g., which may correspond to the data parts 240 as described with reference to FIG. 2), the R2D communication 405 may include a CAP 415 for each data part 425. For example, the CAPs 415 may correspond to the synchronization signals 235 as described with reference to FIG. 2.

For example, as shown in the timing diagram 400, the R2D communication 405 may include a SIP signal 410, a first CAP 415-a, a control part 420, a first data part 425-a, a second CAP 415-b, a second data part 425-b, a third CAP 415-c, and a third data part 425-c. The SIP signal 410 may indicate to an ambient power wireless communication device the beginning of the R2D communication 405. In some examples, the R2D communication 405 may use a different M for data and control. In such examples, the first CAP 415-a may include an indication of the value of M for the control part 420. The control part 420 may indicate the value of M for the data parts 425 (e.g., the quantity of chips per OFDM symbol for the data parts). In some such examples, the subsequent CAPs 415 for each repetition of data (e.g., the second CAP 415-b for the second data part 425-b and the third CAP 415-c for the third data part 425-c) may indicate the value of M for the data parts, which may enable the ambient power wireless communication device to better estimate the quantity of samples per chip. In some examples, whether the data parts 425 include a different value of M than the control part 420 may be indicated in the control part 420.

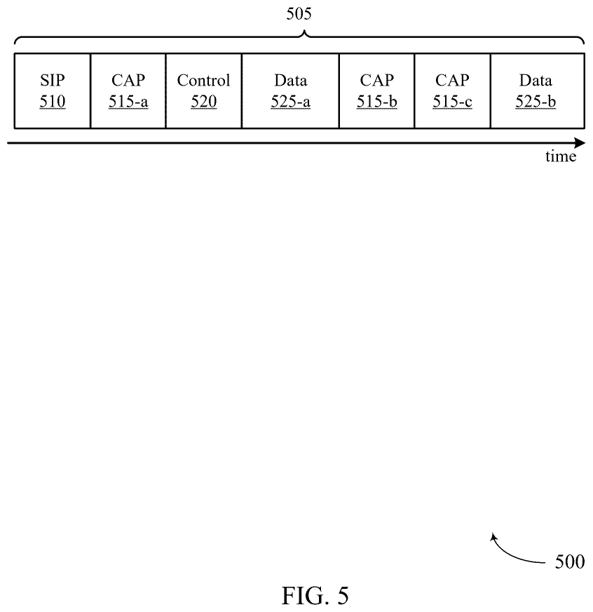

FIG. 5 shows an example of a timing diagram 500 that supports R2D communication with repetition in accordance with one or more aspects of the present disclosure. The timing diagram 500 may implement or may be implemented by aspects of the wireless communications system 100 or the wireless communications system 200. For example, the timing diagram 500 shows an example format of an R2D communication 505, which may be an example of an R2D communication 220 as described herein.

In some examples, where the R2D communication 505 implements block repetition of data parts 525 (e.g., which may correspond to the data parts 240 as described with reference to FIG. 2), the R2D communication 505 may include a CAP 515 for each data part 525. For example, the CAPs 515 may correspond to the synchronization signals 235 as described with reference to FIG. 2. In some examples, subsequent CAPs 515 associated with later repetitions within the R2D communication 505 may be longer than earlier CAPs 515 and/or may be repeated, which may enable the ambient power wireless communication device to better estimate the quantity of samples per chip (which may be a cause of failure in the decoding of a previous repetition within the R2D communication 505).

For example, as shown in the timing diagram 500, the R2D communication 505 may include a SIP signal 510, a first CAP 515-a, a control part 520, a first data part 525-a, a second CAP 515-b, a third CAP 515-c, and a second data part 525-b. The SIP signal 510 may indicate to an ambient power wireless communication device the beginning of the R2D communication 505. An ambient power wireless communication device that receives the R2D communication 505 may use each CAP 515 to refine the estimate of the quantity of samples per chip. In some examples, the CAP 515 may be repeated for the second data part 525-b (e.g., the second CAP 515-b and the third CAP 515-c may be transmitted after the first data part 525-a and prior to the second data part 525-b to enable the ambient power wireless communication device to estimate the quantity of samples per chip for the second data part 525-b). In some examples, a single CAP 515 may be transmitted after the first data part 525-a and prior to the second data part 525-b (e.g., instead of multiple repetitions of the CAP 515), and the single CAP may have a different (e.g., longer) duration than the first CAP 515-a to enable a more accurate estimate of the quantity of samples per chip for the second data part 525-b as compared to the estimate of the quantity of samples per chip for the first data part 525-a based on the first CAP 515-a. In some examples, the control part 520 may indicate the duration of subsequent CAPs 515 within the R2D communication 505 and/or whether subsequent CAPs 515 within the R2D communication 505 will be repeated prior to respective data parts 525 of the R2D communication 505.

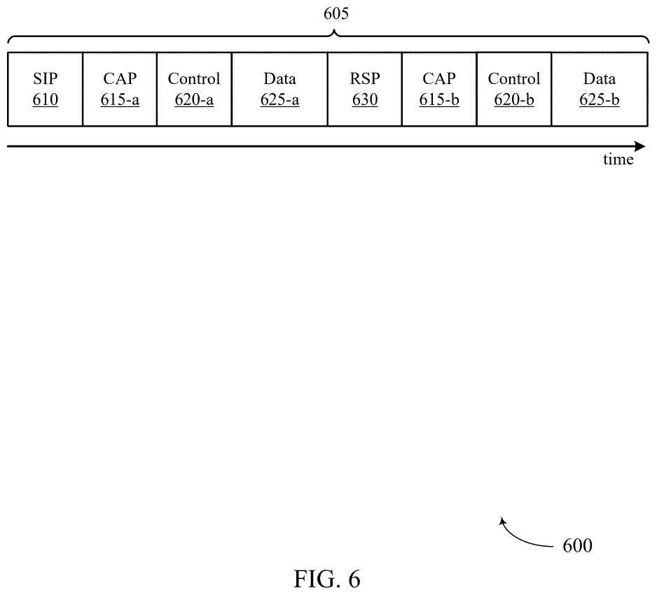

FIG. 6 shows an example of a timing diagram 600 that supports R2D communication with repetition in accordance with one or more aspects of the present disclosure. The timing diagram 600 may implement or may be implemented by aspects of the wireless communications system 100 or the wireless communications system 200. For example, the timing diagram 600 shows an example format of an R2D communication 605, which may be an example of an R2D communication 220 as described herein.

In some examples, where the R2D communication 605 implements block repetition of data parts 625 (e.g., which may correspond to the data parts 240 as described with reference to FIG. 2), the R2D communication 605 may include a CAP 615 for each data part 625 and/or may include a repetition start part 630 for subsequent repetitions (e.g., for data parts 625 after the first data part 625-a). In some examples, as shown in the timing diagram 600, each repetition may include a respective control part 620. In some examples, the first repetition may include a control part 620 but other repetitions may not include control parts (e.g., the R2D communication 605 may include the first control part 620-a but may not include the second control part 620-b).

As shown in the timing diagram 600, the R2D communication 605 may include a SIP signal 610, which may indicate to an ambient power wireless communication device the beginning of the R2D communication 605. An ambient power wireless communication device that receives the R2D communication 605 may use each CAP 615 to refine the estimate of the quantity of samples per chip (e.g., a first CAP 615-a for the first data part 625-a and a second CAP 615-b for the second data part 625-b). The repetition start part 630 may be included to enable the A-IoT to perform a better estimate of the quantity of samples per chip (e.g., as compared to the CAP 615 alone). For example, the synchronization signal for the first repetition (e.g., the first data part 625-a) may be the first CAP 615-a. In some examples, the CAP 615 may be a sequence of “0 1 0 1” or “1 0 1 0”, which may be a valid subsequence of the data query (e.g., a valid sequence for the data part 625), and accordingly an ambient power wireless communication device may be unable to determine the start of a subsequent repetition (e.g., the second data part 625-b) relying solely on the CAP. Accordingly, a repetition start part 630 may use a sequence that violates any Manchester encoded subsequence to indicate the start of a subsequent repetition (e.g., is different from a sequence type used for CAPs or data parts). For example, the repetition start part 630 may indicate the start of the repetition that includes the second data part 625-b (and in some examples, the second control part 620-b). The duration of “on” and “off” states of the repetition start part 630 may be 3 consecutive chips of the data part 625 to prevent a false alarm (e.g., of a data part of CAP). In some examples, the reference sequence of the repetition start part 630 may depend on the value of M for the data parts 625, and the ambient power wireless communication device may run a searcher (e.g., a searcher module or circuitry) for the repetition start part 630 based on the value of M for the data parts 625.

In some examples, the ambient power wireless communication device may not successfully decode the first control part 620-a. In some examples, decoding of a data part 625 may depend on successfully decoding the control part 620 (e.g., the control part 620 may indicate information for decoding the data part 625 such as the value of M for the data part 625). Accordingly, in some examples, as shown in the timing diagram 600, the control part 620 may be repeated for each repetition. For example, the R2D communication 605 may include a first control part 620-a prior to the first data part 625-a and a second control part 620-b prior to the second data part 625-b. In some examples, the control information within each control part 620 may be different (e.g., the first control part 620-a may include different control information than the second control part 620-b). For example, the control parts 620 may include a field that indicates a quantity of repetitions remaining in the R2D communication 605, and thus each subsequent control part 620 may include a value for the field that indicates the quantity of repetitions remaining in the R2D communication 605 that is decremented by one.

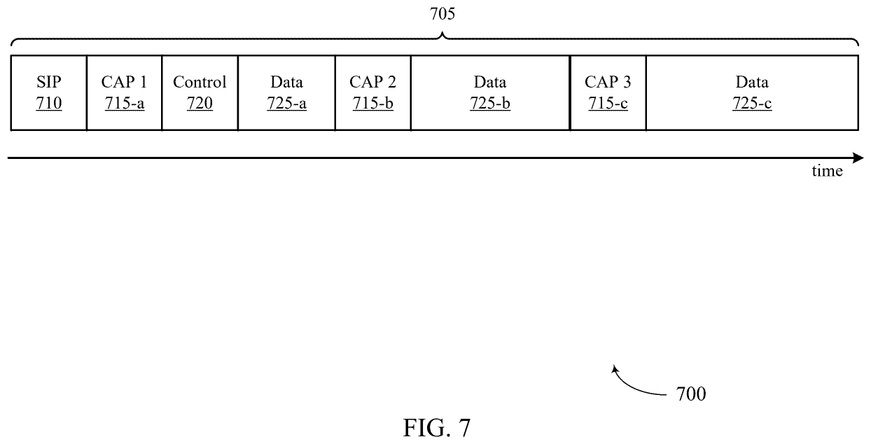

FIG. 7 shows an example of a timing diagram 700 that supports R2D communication with repetition in accordance with one or more aspects of the present disclosure. The timing diagram 700 may implement or may be implemented by aspects of the wireless communications system 100 or the wireless communications system 200. For example, the timing diagram 700 shows an example format of an R2D communication 705, which may be an example of an R2D communication 220 as described herein.

In some examples, where the R2D communication 705 implements block repetition of data parts 725 (e.g., which may correspond to the data parts 240 as described with reference to FIG. 2), the R2D communication 705 may include a CAP 715 for each data part 725. For example, the CAPs 715 may correspond to the synchronization signals 235 as described with reference to FIG. 2. For example, as shown in the timing diagram 700, the R2D communication 705 may include a SIP signal 710, a first CAP 715-a, a control part 720, a first data part 725-a, a second CAP 715-b, a second data part 725-b, a third CAP 715-c, and a third data part 725-c. The SIP signal 710 may indicate to an ambient power wireless communication device the beginning of the R2D communication 705.

In some examples, the different data parts 725 may use different values of M. For example, longer chips (e.g., smaller values of M) may be used for later data parts 725 to increase the processing gain, and thus increase the likelihood that the ambient power wireless communication device is able to successfully decode the later data part. For example, the second data part 725-b may use a smaller value of M (and thus may have a longer duration than) the first data part 725-a, and the third data part 725-c may use a smaller value of M (and thus may have a longer duration than) the second data part 725-b. In some examples, the first CAP 715-a may indicate the value of M for the control part 720, the control part 720 may indicate the value of M for the first data part 725-a, the second CAP 715-b may indicate the value of M for the second data part 725-b, and the third CAP 715-c may indicate the value of M for the third data part 725-c.

As the ambient power wireless communication device may attempt to decode a subsequent data part 725 within the R2D communication 705 if the ambient power wireless communication device was not able to successfully decode an earlier data part 725 of the R2D communication 705, using a smaller value of M for later data parts increases the likelihood that the ambient power wireless communication device will be able to successfully decode the later data part (e.g., to compensate for poor channel conditions which may have caused the ambient power wireless communication device to be unable to decode the earlier data part 725).

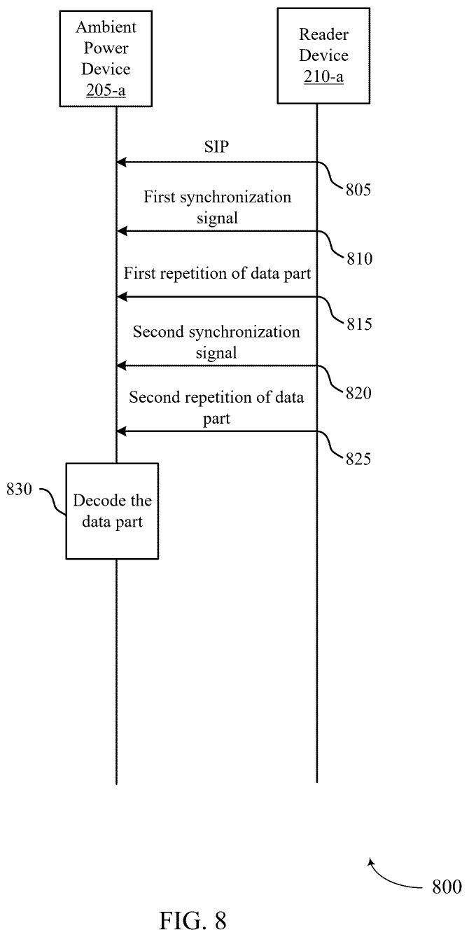

FIG. 8 shows an example of a process flow 800 that supports R2D communication with repetition in accordance with one or more aspects of the present disclosure. The process flow 800 may implement or may be implemented by aspects of the wireless communications system 100, the wireless communications system 200, the timing diagram 300, the timing diagram 400, the timing diagram 500, the timing diagram 600, or the timing diagram 700. For example, the process flow 800 may include an ambient power wireless communication device 205-a and a reader device 210-a, which may be examples of an ambient power wireless communication device 205 and a reader device 210, respectively, as described herein.

In the following description of the process flow 800, the operations between the ambient power wireless communication device 205-a and the reader device 210-a may be performed in a different order than the example order shown. Some operations may also be omitted from the process flow 800, and other operations may be added to the process flow 800. Further, although some operations or signaling may be shown to occur at different times for discussion purposes, these operations may actually occur at the same time.

At 805, the ambient power wireless communication device 205-a may receive, from the reader device 210-a, a SIP signal of an R2D communication. The SIP signal may indicate beginning of the R2D communication and may indicate for the ambient power wireless communication device 205-a to monitor for one or more data part repetitions of the R2D communication.

At 810, the ambient power wireless communication device 205-a may receive, from the reader device 210-a, a first synchronization signal of the R2D communication based on the SIP signal.

At 815, the ambient power wireless communication device 205-a may monitor for, and the reader device 210-a may transmit, a first repetition of a data part of the R2D communication based on the first synchronization signal.

At 820, the ambient power wireless communication device 205-a may receive, from the reader device 210-a, a second synchronization signal of the R2D communication associated with a second repetition of the data part.

At 825, the ambient power wireless communication device 205-a may monitor for, and the reader device 210-a may transmit, a second repetition of a data part of the R2D communication based on the second synchronization signal.

At 830, the ambient power wireless communication device 205-a may decode the data part based on monitoring for the first repetition at 815, the second repetition at 825, or both.

In some examples, the first synchronization signal is a first CAP signal and the second synchronization signal is a second CAP signal.

In some examples, the first synchronization signal is a first CAP signal having a first sequence type and the second synchronization signal is a repetition start part signal having a second sequence type different than the first sequence type. In some such examples, the ambient power wireless communication device 205-a may receive, from the reader device 210-a, a second CAP prior to the second repetition of the data part and after the second synchronization signal, where the second CAP has the first sequence type.

In some examples, the ambient power wireless communication device 205-a may receive, from the reader device 210-a, a control part of the R2D communication prior to the first repetition and based on the first synchronization signal. In some examples, the first synchronization signal indicates a first quantity of chips per OFDM symbol associated with the control part (e.g., a first value of M), and the control part indicates a second quantity of chips per OFDM symbol associated with the first repetition (e.g., a second, different value of M). In some examples, the second synchronization signal indicates a third quantity of chips per OFDM symbol (e.g., a third, different value of M) associated with the second repetition. In some examples, the ambient power wireless communication device 205-a may receive, from the reader device 210-a, a second control part of the R2D communication prior to the second repetition and based on the second synchronization signal. In some examples, the ambient power wireless communication device 205-a may transmit, to the reader device 210-a, a D2R communication based on scheduling information included in the control part. In some examples, the second synchronization signal may have a different (e.g., shorter) duration than the first synchronization signal. In some examples, the first repetition may have a different (e.g., shorter) duration than the second repetition.

In some examples, the ambient power wireless communication device 205-a may receive, from the reader device 210-a, a third synchronization signal of the R2D communication associated with a third repetition of the data part. In some such examples, the ambient power wireless communication device 205-a may monitor for, and the reader device 210-a may transmit, a third repetition of a data part of the R2D communication based on the third synchronization signal. For example, any quantity of repetitions of the data part may be included in the R2D signal. In some examples, as described herein, each repetition of the data part may be preceded by an associated synchronization signal.

In some examples, a first quantity of chips per OFDM symbol associated with the first repetition may be different from (e.g., higher than) a second quantity of chips per OFDM symbol associated with the second repetition.

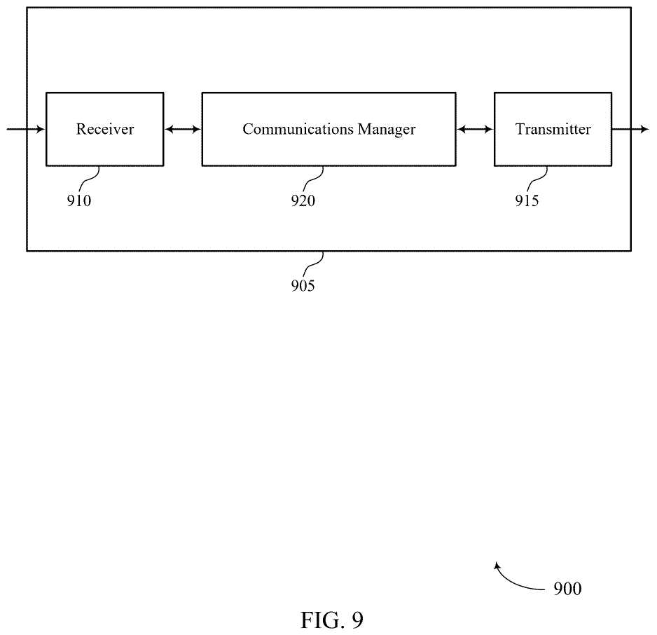

FIG. 9 shows a block diagram 900 of a device 905 that supports R2D communication with repetition in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to R2D communication with repetition). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to R2D communication with repetition). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of R2D communication with repetition as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a reader device, a SIP signal of a R2D communication, the SIP signal indicating a beginning of the R2D communication and indicating for the ambient power wireless communication device to monitor for one or more data part repetitions of the R2D communication. The communications manager 920 is capable of, configured to, or operable to support a means for receiving a first synchronization signal of the R2D communication based on the SIP signal. The communications manager 920 is capable of, configured to, or operable to support a means for monitoring for a first repetition of a data part of the R2D communication based on the first synchronization signal. The communications manager 920 is capable of, configured to, or operable to support a means for receiving a second synchronization signal of the R2D communication associated with a second repetition of the data part. The communications manager 920 is capable of, configured to, or operable to support a means for monitoring for the second repetition of the data part based on the second synchronization signal. The communications manager 920 is capable of, configured to, or operable to support a means for decoding the data part based on monitoring for the first repetition, the second repetition, or both.

Additionally, or alternatively, the communications manager 920 may support wireless communications in accordance with examples as disclosed herein. For example, the communications manager 920 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The communications manager 920 is capable of, configured to, or operable to support a means for transmitting a first synchronization signal of the R2D communication based on the SIP signal. The communications manager 920 is capable of, configured to, or operable to support a means for transmitting a first repetition of a data part of the R2D communication based on the first synchronization signal. The communications manager 920 is capable of, configured to, or operable to support a means for transmitting a second synchronization signal of the R2D communication associated with a second repetition of the data part. The communications manager 920 is capable of, configured to, or operable to support a means for transmitting the second repetition of the data part based on the second synchronization signal.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

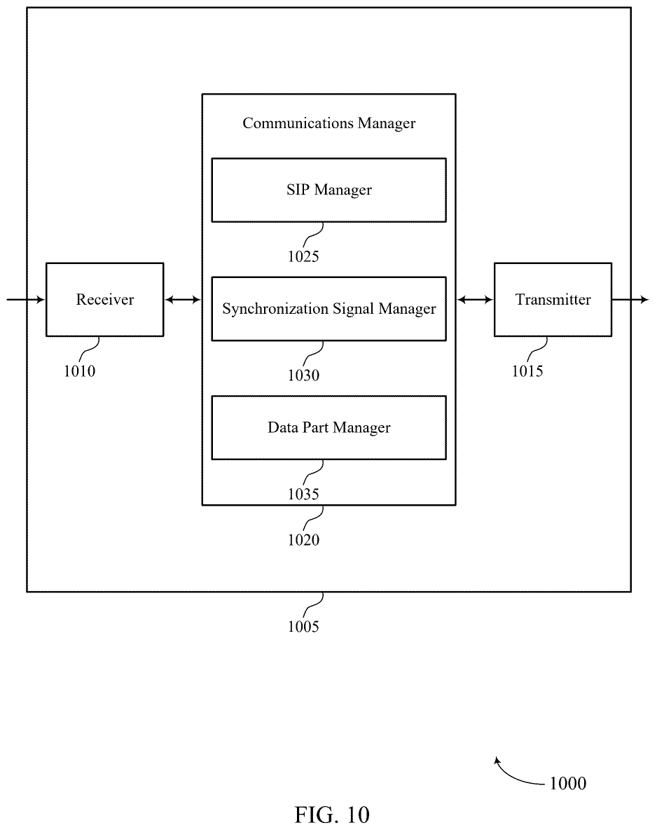

FIG. 10 shows a block diagram 1000 of a device 1005 that supports R2D communication with repetition in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to R2D communication with repetition). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to R2D communication with repetition). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of R2D communication with repetition as described herein. For example, the communications manager 1020 may include an SIP manager 1025, a synchronization signal manager 1030, a data part manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SIP manager 1025 is capable of, configured to, or operable to support a means for receiving, from a reader device, a SIP signal of a R2D communication, the SIP signal indicating a beginning of the R2D communication and indicating for the ambient power wireless communication device to monitor for one or more data part repetitions of the R2D communication. The synchronization signal manager 1030 is capable of, configured to, or operable to support a means for receiving a first synchronization signal of the R2D communication based on the SIP signal. The data part manager 1035 is capable of, configured to, or operable to support a means for monitoring for a first repetition of a data part of the R2D communication based on the first synchronization signal. The synchronization signal manager 1030 is capable of, configured to, or operable to support a means for receiving a second synchronization signal of the R2D communication associated with a second repetition of the data part. The data part manager 1035 is capable of, configured to, or operable to support a means for monitoring for the second repetition of the data part based on the second synchronization signal. The data part manager 1035 is capable of, configured to, or operable to support a means for decoding the data part based on monitoring for the first repetition, the second repetition, or both.

Additionally, or alternatively, the communications manager 1020 may support wireless communications in accordance with examples as disclosed herein. The SIP manager 1025 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The synchronization signal manager 1030 is capable of, configured to, or operable to support a means for transmitting a first synchronization signal of the R2D communication based on the SIP signal. The data part manager 1035 is capable of, configured to, or operable to support a means for transmitting a first repetition of a data part of the R2D communication based on the first synchronization signal. The synchronization signal manager 1030 is capable of, configured to, or operable to support a means for transmitting a second synchronization signal of the R2D communication associated with a second repetition of the data part. The data part manager 1035 is capable of, configured to, or operable to support a means for transmitting the second repetition of the data part based on the second synchronization signal.

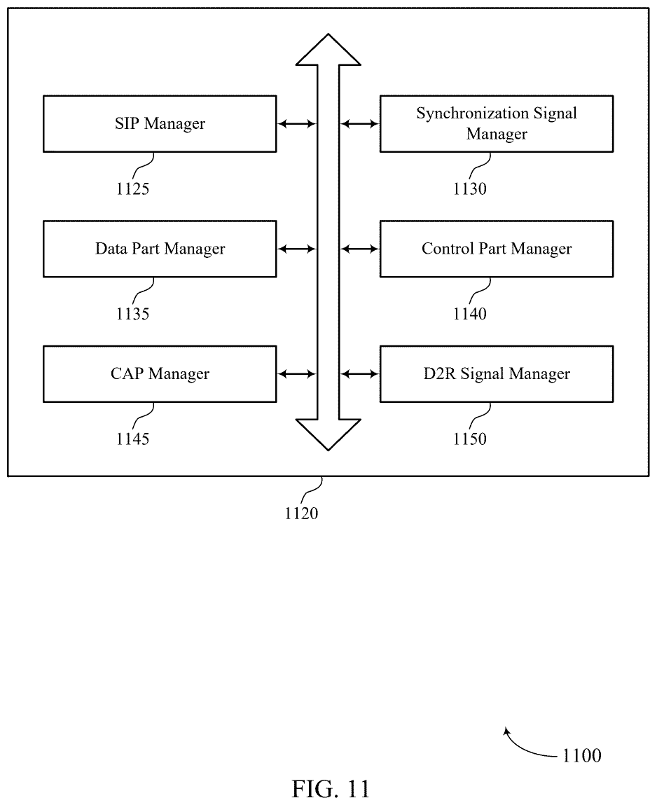

FIG. 11 shows a block diagram 1100 of a communications manager 1120 that supports R2D communication with repetition in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of R2D communication with repetition as described herein. For example, the communications manager 1120 may include an SIP manager 1125, a synchronization signal manager 1130, a data part manager 1135, a control part manager 1140, a CAP manager 1145, a D2R signal manager 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The SIP manager 1125 is capable of, configured to, or operable to support a means for receiving, from a reader device, a SIP signal of a R2D communication, the SIP signal indicating a beginning of the R2D communication and indicating for the ambient power wireless communication device to monitor for one or more data part repetitions of the R2D communication. The synchronization signal manager 1130 is capable of, configured to, or operable to support a means for receiving a first synchronization signal of the R2D communication based on the SIP signal. The data part manager 1135 is capable of, configured to, or operable to support a means for monitoring for a first repetition of a data part of the R2D communication based on the first synchronization signal. In some examples, the synchronization signal manager 1130 is capable of, configured to, or operable to support a means for receiving a second synchronization signal of the R2D communication associated with a second repetition of the data part. In some examples, the data part manager 1135 is capable of, configured to, or operable to support a means for monitoring for the second repetition of the data part based on the second synchronization signal. In some examples, the data part manager 1135 is capable of, configured to, or operable to support a means for decoding the data part based on monitoring for the first repetition, the second repetition, or both.

In some examples, the first synchronization signal is a first CAP signal. In some examples, the second synchronization signal is a second CAP signal.

In some examples, the first synchronization signal is a first CAP signal having a first sequence type. In some examples, the second synchronization signal is a repetition start part signal having a second sequence type different than the first sequence type.

In some examples, the CAP manager 1145 is capable of, configured to, or operable to support a means for receiving, after the second synchronization signal and prior to the second repetition, a second CAP signal having the first sequence type.

In some examples, the control part manager 1140 is capable of, configured to, or operable to support a means for receiving a control part of the R2D communication prior to the first repetition and based on the first synchronization signal.

In some examples, the first synchronization signal indicates a first quantity of chips per OFDM symbol associated with the control part. In some examples, the control part indicates a second quantity of chips per OFDM symbol associated with the first repetition.

In some examples, the second synchronization signal indicates a third quantity of chips per OFDM symbol associated with the second repetition.

In some examples, the control part manager 1140 is capable of, configured to, or operable to support a means for receiving a second control part of the R2D communication prior to the second repetition and based on the second synchronization signal.

In some examples, the D2R signal manager 1150 is capable of, configured to, or operable to support a means for transmitting a D2R communication based on scheduling information included in the control part.

In some examples, the second synchronization signal has a different duration than the first synchronization signal.

In some examples, the synchronization signal manager 1130 is capable of, configured to, or operable to support a means for receiving a third synchronization signal of the R2D communication associated with a third repetition of the data part. In some examples, the data part manager 1135 is capable of, configured to, or operable to support a means for monitoring for the third repetition of the data part based on the third synchronization signal.

In some examples, a first quantity of chips per OFDM symbol associated with the first repetition is higher than a second quantity of chips per OFDM symbol associated with the second repetition.

Additionally, or alternatively, the communications manager 1120 may support wireless communications in accordance with examples as disclosed herein. In some examples, the SIP manager 1125 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. In some examples, the synchronization signal manager 1130 is capable of, configured to, or operable to support a means for transmitting a first synchronization signal of the R2D communication based on the SIP signal. In some examples, the data part manager 1135 is capable of, configured to, or operable to support a means for transmitting a first repetition of a data part of the R2D communication based on the first synchronization signal. In some examples, the synchronization signal manager 1130 is capable of, configured to, or operable to support a means for transmitting a second synchronization signal of the R2D communication associated with a second repetition of the data part. In some examples, the data part manager 1135 is capable of, configured to, or operable to support a means for transmitting the second repetition of the data part based on the second synchronization signal.

In some examples, the first synchronization signal is a first CAP signal. In some examples, the second synchronization signal is a second CAP signal.

In some examples, the first synchronization signal is a first CAP signal having a first sequence type. In some examples, the second synchronization signal is a repetition start part signal having a second sequence type different than the first sequence type.

In some examples, the CAP manager 1145 is capable of, configured to, or operable to support a means for transmitting, after the second synchronization signal and prior to the second repetition, a second CAP signal having the first sequence type.

In some examples, the control part manager 1140 is capable of, configured to, or operable to support a means for transmitting a control part of the R2D communication prior to the first repetition and based on the first synchronization signal.

In some examples, the first synchronization signal indicates a first quantity of chips per OFDM symbol associated with the control part. In some examples, the control part indicates a second quantity of chips per OFDM symbol associated with the first repetition.

In some examples, the second synchronization signal indicates a third quantity of chips per OFDM symbol associated with the second repetition.

In some examples, the control part manager 1140 is capable of, configured to, or operable to support a means for transmitting a second control part of the R2D communication prior to the second repetition and based on the second synchronization signal.

In some examples, the D2R signal manager 1150 is capable of, configured to, or operable to support a means for receiving, from the ambient power wireless communication device, a D2R communication based on scheduling information included in the control part.

In some examples, the second synchronization signal has a different duration than the first synchronization signal.

In some examples, the synchronization signal manager 1130 is capable of, configured to, or operable to support a means for transmitting a third synchronization signal of the R2D communication. In some examples, the data part manager 1135 is capable of, configured to, or operable to support a means for transmitting a third repetition of the data part based on the third synchronization signal.

In some examples, a first quantity of chips per OFDM symbol associated with the first repetition is higher than a second quantity of chips per OFDM symbol associated with the second repetition.

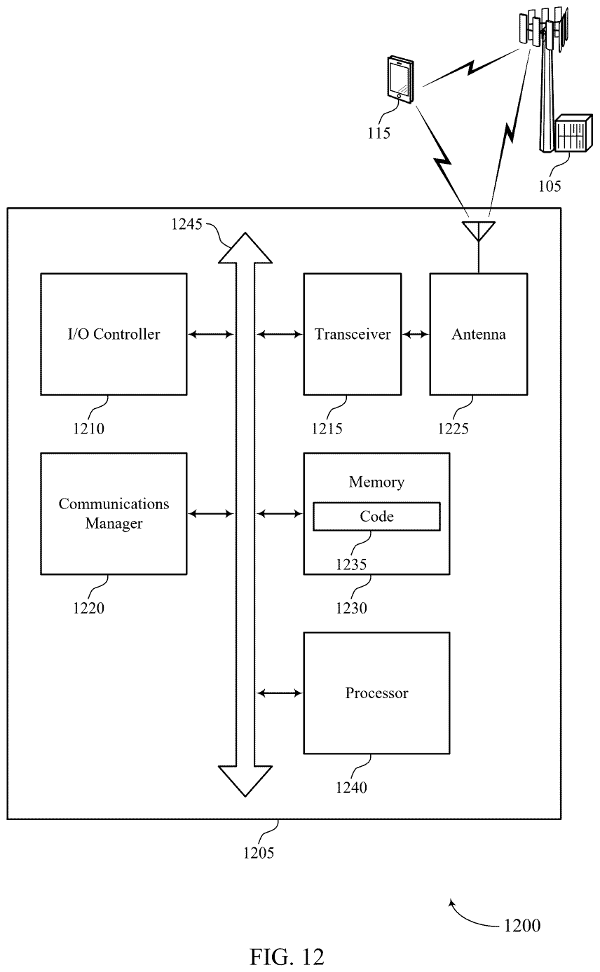

FIG. 12 shows a diagram of a system 1200 including a device 1205 that supports R2D communication with repetition in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting R2D communication with repetition). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving, from a reader device, a SIP signal of a R2D communication, the SIP signal indicating a beginning of the R2D communication and indicating for the ambient power wireless communication device to monitor for one or more data part repetitions of the R2D communication. The communications manager 1220 is capable of, configured to, or operable to support a means for receiving a first synchronization signal of the R2D communication based on the SIP signal. The communications manager 1220 is capable of, configured to, or operable to support a means for monitoring for a first repetition of a data part of the R2D communication based on the first synchronization signal. The communications manager 1220 is capable of, configured to, or operable to support a means for receiving a second synchronization signal of the R2D communication associated with a second repetition of the data part. The communications manager 1220 is capable of, configured to, or operable to support a means for monitoring for the second repetition of the data part based on the second synchronization signal. The communications manager 1220 is capable of, configured to, or operable to support a means for decoding the data part based on monitoring for the first repetition, the second repetition, or both.

Additionally, or alternatively, the communications manager 1220 may support wireless communications in accordance with examples as disclosed herein. For example, the communications manager 1220 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The communications manager 1220 is capable of, configured to, or operable to support a means for transmitting a first synchronization signal of the R2D communication based on the SIP signal. The communications manager 1220 is capable of, configured to, or operable to support a means for transmitting a first repetition of a data part of the R2D communication based on the first synchronization signal. The communications manager 1220 is capable of, configured to, or operable to support a means for transmitting a second synchronization signal of the R2D communication associated with a second repetition of the data part. The communications manager 1220 is capable of, configured to, or operable to support a means for transmitting the second repetition of the data part based on the second synchronization signal.

By including or configuring the communications manager 1220 in accordance with examples as described herein, the device 1205 may support techniques for improved communication reliability, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of R2D communication with repetition as described herein, or the at least one processor 1240 and the at least one memory 1230 may be otherwise configured to, individually or collectively, perform or support such operations.

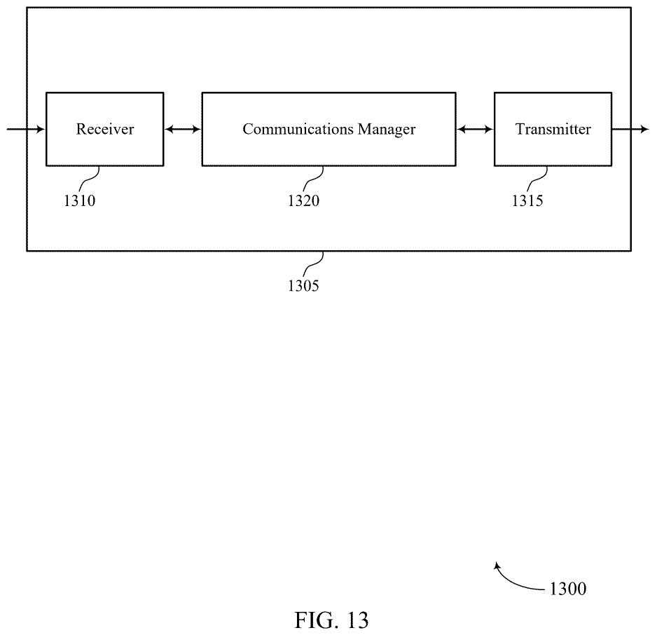

FIG. 13 shows a block diagram 1300 of a device 1305 that supports R2D communication with repetition in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of R2D communication with repetition as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The communications manager 1320 is capable of, configured to, or operable to support a means for transmitting a first synchronization signal of the R2D communication based on the SIP signal. The communications manager 1320 is capable of, configured to, or operable to support a means for transmitting a first repetition of a data part of the R2D communication based on the first synchronization signal. The communications manager 1320 is capable of, configured to, or operable to support a means for transmitting a second synchronization signal of the R2D communication associated with a second repetition of the data part. The communications manager 1320 is capable of, configured to, or operable to support a means for transmitting the second repetition of the data part based on the second synchronization signal.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources.

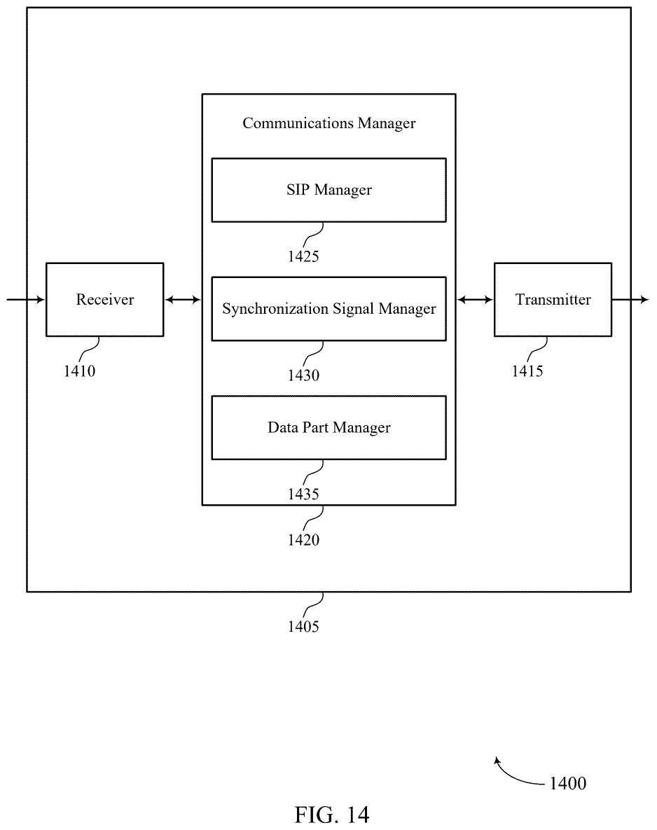

FIG. 14 shows a block diagram 1400 of a device 1405 that supports R2D communication with repetition in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of R2D communication with repetition as described herein. For example, the communications manager 1420 may include an SIP manager 1425, a synchronization signal manager 1430, a data part manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The SIP manager 1425 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The synchronization signal manager 1430 is capable of, configured to, or operable to support a means for transmitting a first synchronization signal of the R2D communication based on the SIP signal. The data part manager 1435 is capable of, configured to, or operable to support a means for transmitting a first repetition of a data part of the R2D communication based on the first synchronization signal. The synchronization signal manager 1430 is capable of, configured to, or operable to support a means for transmitting a second synchronization signal of the R2D communication associated with a second repetition of the data part. The data part manager 1435 is capable of, configured to, or operable to support a means for transmitting the second repetition of the data part based on the second synchronization signal.

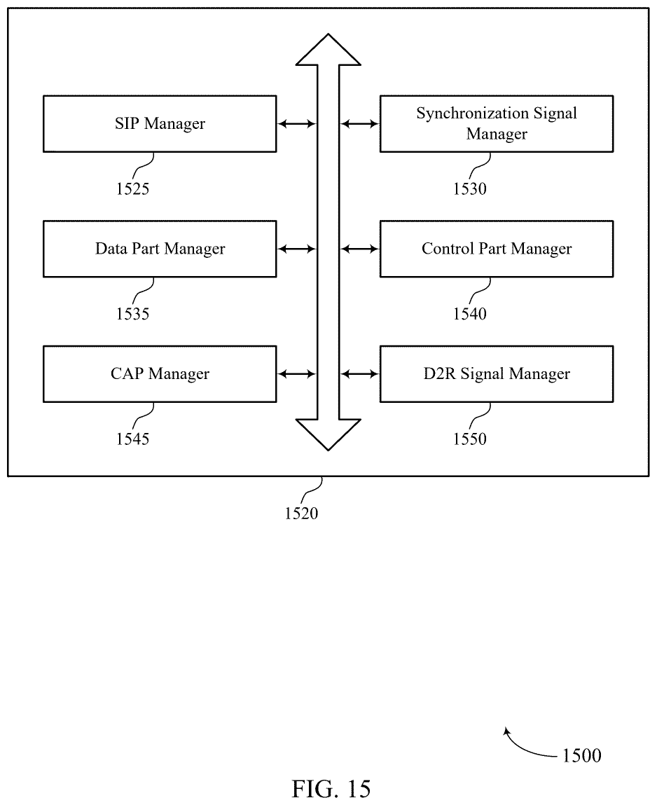

FIG. 15 shows a block diagram 1500 of a communications manager 1520 that supports R2D communication with repetition in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of R2D communication with repetition as described herein. For example, the communications manager 1520 may include an SIP manager 1525, a synchronization signal manager 1530, a data part manager 1535, a control part manager 1540, a CAP manager 1545, a D2R signal manager 1550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The SIP manager 1525 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The synchronization signal manager 1530 is capable of, configured to, or operable to support a means for transmitting a first synchronization signal of the R2D communication based on the SIP signal. The data part manager 1535 is capable of, configured to, or operable to support a means for transmitting a first repetition of a data part of the R2D communication based on the first synchronization signal. In some examples, the synchronization signal manager 1530 is capable of, configured to, or operable to support a means for transmitting a second synchronization signal of the R2D communication associated with a second repetition of the data part. In some examples, the data part manager 1535 is capable of, configured to, or operable to support a means for transmitting the second repetition of the data part based on the second synchronization signal.

In some examples, the first synchronization signal is a first CAP signal. In some examples, the second synchronization signal is a second CAP signal.

In some examples, the first synchronization signal is a first CAP signal having a first sequence type. In some examples, the second synchronization signal is a repetition start part signal having a second sequence type different than the first sequence type.

In some examples, the CAP manager 1545 is capable of, configured to, or operable to support a means for transmitting, after the second synchronization signal and prior to the second repetition, a second CAP signal having the first sequence type.

In some examples, the control part manager 1540 is capable of, configured to, or operable to support a means for transmitting a control part of the R2D communication prior to the first repetition and based on the first synchronization signal.

In some examples, the first synchronization signal indicates a first quantity of chips per OFDM symbol associated with the control part. In some examples, the control part indicates a second quantity of chips per OFDM symbol associated with the first repetition.

In some examples, the second synchronization signal indicates a third quantity of chips per OFDM symbol associated with the second repetition.

In some examples, the control part manager 1540 is capable of, configured to, or operable to support a means for transmitting a second control part of the R2D communication prior to the second repetition and based on the second synchronization signal.

In some examples, the D2R signal manager 1550 is capable of, configured to, or operable to support a means for receiving, from the ambient power wireless communication device, a device to reader communication based on scheduling information included in the control part.

In some examples, the second synchronization signal has a different duration than the first synchronization signal.

In some examples, the synchronization signal manager 1530 is capable of, configured to, or operable to support a means for transmitting a third synchronization signal of the R2D communication. In some examples, the data part manager 1535 is capable of, configured to, or operable to support a means for transmitting a third repetition of the data part based on the third synchronization signal.

In some examples, a first quantity of chips per OFDM symbol associated with the first repetition is higher than a second quantity of chips per OFDM symbol associated with the second repetition.

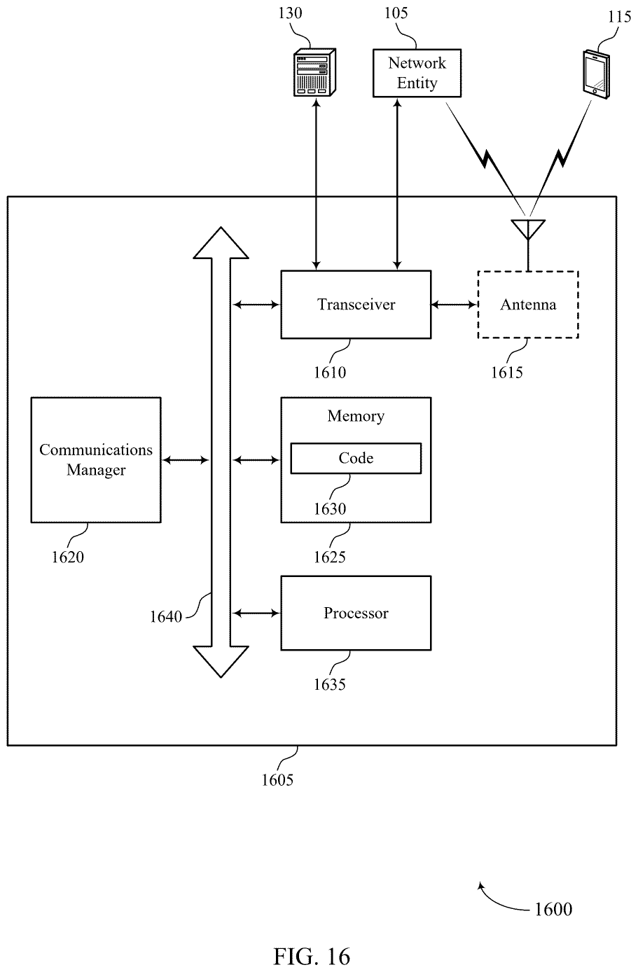

FIG. 16 shows a diagram of a system 1600 including a device 1605 that supports R2D communication with repetition in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting R2D communication with repetition). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The communications manager 1620 is capable of, configured to, or operable to support a means for transmitting a first synchronization signal of the R2D communication based on the SIP signal. The communications manager 1620 is capable of, configured to, or operable to support a means for transmitting a first repetition of a data part of the R2D communication based on the first synchronization signal. The communications manager 1620 is capable of, configured to, or operable to support a means for transmitting a second synchronization signal of the R2D communication associated with a second repetition of the data part. The communications manager 1620 is capable of, configured to, or operable to support a means for transmitting the second repetition of the data part based on the second synchronization signal.

By including or configuring the communications manager 1620 in accordance with examples as described herein, the device 1605 may support techniques for improved communication reliability, more efficient utilization of communication resources, improved coordination between devices, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of R2D communication with repetition as described herein, or the at least one processor 1635 and the at least one memory 1625 may be otherwise configured to, individually or collectively, perform or support such operations.

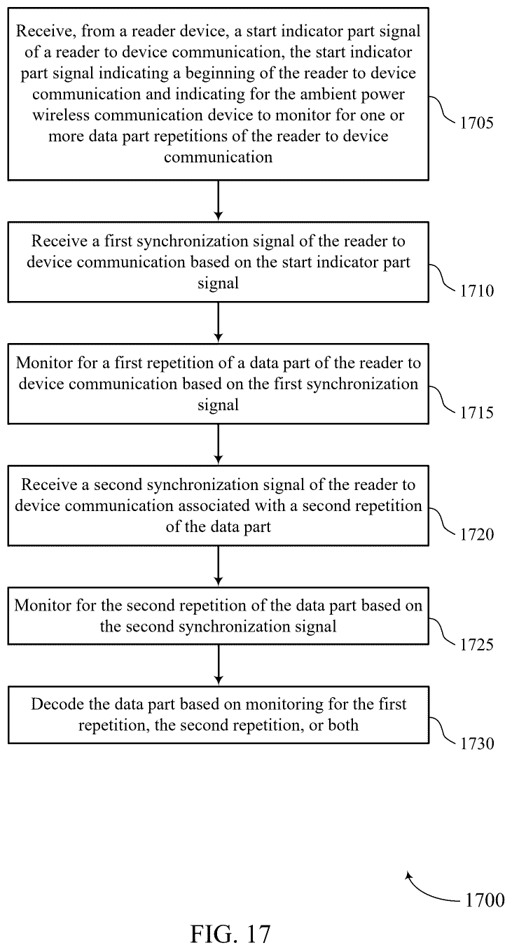

FIG. 17 shows a flowchart illustrating a method 1700 that supports R2D communication with repetition in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a reader device, a SIP signal of a R2D communication, the SIP signal indicating a beginning of the R2D communication and indicating for the ambient power wireless communication device to monitor for one or more data part repetitions of the R2D communication. The operations of 1705 may be performed in accordance with examples as disclosed herein. In some examples, aspects of the operations of 1705 may be performed by an SIP manager 1125 as described with reference to FIG. 11.

At 1710, the method may include receiving a first synchronization signal of the R2D communication based on the SIP signal. The operations of 1710 may be performed in accordance with examples as disclosed herein. In some examples, aspects of the operations of 1710 may be performed by a synchronization signal manager 1130 as described with reference to FIG. 11.

At 1715, the method may include monitoring for a first repetition of a data part of the R2D communication based on the first synchronization signal. The operations of 1715 may be performed in accordance with examples as disclosed herein. In some examples, aspects of the operations of 1715 may be performed by a data part manager 1135 as described with reference to FIG. 11.

At 1720, the method may include receiving a second synchronization signal of the R2D communication associated with a second repetition of the data part. The operations of 1720 may be performed in accordance with examples as disclosed herein. In some examples, aspects of the operations of 1720 may be performed by a synchronization signal manager 1130 as described with reference to FIG. 11.

At 1725, the method may include monitoring for the second repetition of the data part based on the second synchronization signal. The operations of 1725 may be performed in accordance with examples as disclosed herein. In some examples, aspects of the operations of 1725 may be performed by a data part manager 1135 as described with reference to FIG. 11.

At 1730, the method may include decoding the data part based on monitoring for the first repetition, the second repetition, or both. The operations of 1730 may be performed in accordance with examples as disclosed herein. In some examples, aspects of the operations of 1730 may be performed by a data part manager 1135 as described with reference to FIG. 11.

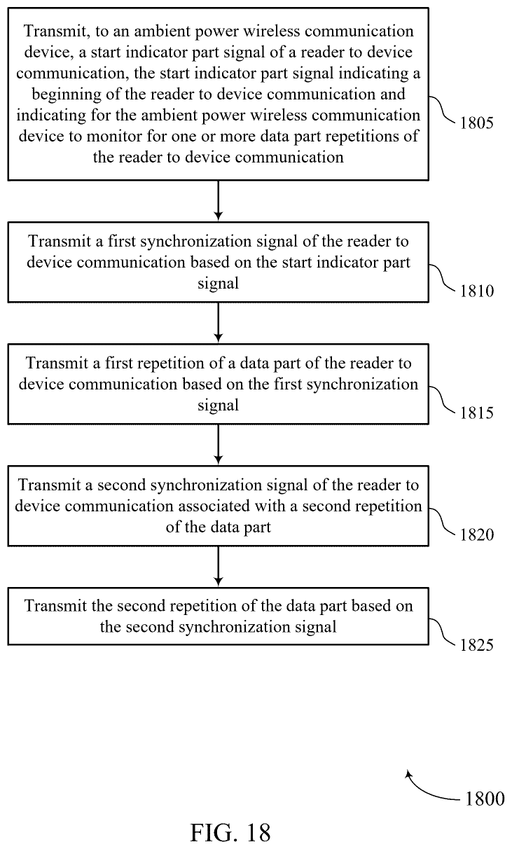

FIG. 18 shows a flowchart illustrating a method 1800 that supports R2D communication with repetition in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include transmitting, to an ambient power wireless communication device, a SIP signal of a R2D communication, the SIP signal indicating a beginning of the R2D communication and indicating for the ambient power wireless communication device to monitor for one or more data part repetitions of the R2D communication. The operations of 1805 may be performed in accordance with examples as disclosed herein. In some examples, aspects of the operations of 1805 may be performed by an SIP manager 1125 or an SIP manager 1525 as described with reference to FIGS. 11 and 15.

At 1810, the method may include transmitting a first synchronization signal of the R2D communication based on the SIP signal. The operations of 1810 may be performed in accordance with examples as disclosed herein. In some examples, aspects of the operations of 1810 may be performed by a synchronization signal manager 1130 or a synchronization signal manager 1530 as described with reference to FIGS. 11 and 15.

At 1815, the method may include transmitting a first repetition of a data part of the R2D communication based on the first synchronization signal. The operations of 1815 may be performed in accordance with examples as disclosed herein. In some examples, aspects of the operations of 1815 may be performed by a data part manager 1135 or a data part manager 1535 as described with reference to FIGS. 11 and 15.

At 1820, the method may include transmitting a second synchronization signal of the R2D communication associated with a second repetition of the data part. The operations of 1820 may be performed in accordance with examples as disclosed herein. In some examples, aspects of the operations of 1820 may be performed by a synchronization signal manager 1130 or a synchronization signal manager 1530 as described with reference to FIGS. 11 and 15.

At 1825, the method may include transmitting the second repetition of the data part based on the second synchronization signal. The operations of 1825 may be performed in accordance with examples as disclosed herein. In some examples, aspects of the operations of 1825 may be performed by a data part manager 1135 or a data part manager 1535 as described with reference to FIGS. 11 and 15.

The following provides an overview of aspects of the present disclosure:

Aspect 1: A method for wireless communications at an ambient power wireless communication device, comprising: receiving, from a reader device, a SIP signal of a R2D communication, the SIP signal indicating a beginning of the R2D communication and indicating for the ambient power wireless communication device to monitor for one or more data part repetitions of the R2D communication; receiving a first synchronization signal of the R2D communication based at least in part on the SIP signal; monitoring for a first repetition of a data part of the R2D communication based at least in part on the first synchronization signal; receiving a second synchronization signal of the R2D communication associated with a second repetition of the data part; monitoring for the second repetition of the data part based at least in part on the second synchronization signal; and decoding the data part based at least in part on monitoring for the first repetition, the second repetition, or both.

Aspect 2: The method of aspect 1, wherein the first synchronization signal is a first CAP signal, and the second synchronization signal is a second CAP signal.

Aspect 3: The method of aspect 1, wherein the first synchronization signal is a first CAP signal having a first sequence type, and the second synchronization signal is a repetition start part signal having a second sequence type different than the first sequence type.

Aspect 4: The method of aspect 3, further comprising: receiving, after the second synchronization signal and prior to the second repetition, a second CAP signal having the first sequence type.

Aspect 5: The method of any of aspects 1 through 4, further comprising: receiving a control part of the R2D communication prior to the first repetition and based at least in part on the first synchronization signal.

Aspect 6: The method of aspect 5, wherein the first synchronization signal indicates a first quantity of chips per OFDM symbol associated with the control part, and the control part indicates a second quantity of chips per OFDM symbol associated with the first repetition.

Aspect 7: The method of aspect 6, wherein the second synchronization signal indicates a third quantity of chips per OFDM symbol associated with the second repetition.

Aspect 8: The method of any of aspects 5 through 7, further comprising: receiving a second control part of the R2D communication prior to the second repetition and based at least in part on the second synchronization signal.

Aspect 9: The method of any of aspects 5 through 8, further comprising: transmitting a D2R communication based at least in part on scheduling information included in the control part.

Aspect 10: The method of any of aspects 5 through 9, wherein the second synchronization signal has a different duration than the first synchronization signal.

Aspect 11: The method of any of aspects 1 through 10, further comprising: receiving a third synchronization signal of the R2D communication associated with a third repetition of the data part; and monitoring for the third repetition of the data part based at least in part on the third synchronization signal.

Aspect 12: The method of any of aspects 1 through 11, wherein a first quantity of chips per OFDM symbol associated with the first repetition is higher than a second quantity of chips per OFDM symbol associated with the second repetition.

Aspect 13: A method for wireless communications at a reader device, comprising: transmitting, to an ambient power wireless communication device, a SIP signal of a R2D communication, the SIP signal indicating a beginning of the R2D communication and indicating for the ambient power wireless communication device to monitor for one or more data part repetitions of the R2D communication; transmitting a first synchronization signal of the R2D communication based at least in part on the SIP signal; transmitting a first repetition of a data part of the R2D communication based at least in part on the first synchronization signal; transmitting a second synchronization signal of the R2D communication associated with a second repetition of the data part; and transmitting the second repetition of the data part based at least in part on the second synchronization signal.

Aspect 14: The method of aspect 13, wherein the first synchronization signal is a first CAP signal, and the second synchronization signal is a second CAP signal.

Aspect 15: The method of aspect 13, wherein the first synchronization signal is a first CAP signal having a first sequence type, and the second synchronization signal is a repetition start part signal having a second sequence type different than the first sequence type.

Aspect 16: The method of aspect 15, further comprising: transmitting, after the second synchronization signal and prior to the second repetition, a second CAP signal having the first sequence type.

Aspect 17: The method of any of aspects 13 through 16, further comprising: transmitting a control part of the R2D communication prior to the first repetition and based at least in part on the first synchronization signal.

Aspect 18: The method of aspect 17, wherein the first synchronization signal indicates a first quantity of chips per OFDM symbol associated with the control part, and the control part indicates a second quantity of chips per OFDM symbol associated with the first repetition.

Aspect 19: The method of aspect 18, wherein the second synchronization signal indicates a third quantity of chips per OFDM symbol associated with the second repetition.

Aspect 20: The method of any of aspects 17 through 19, further comprising: transmitting a second control part of the R2D communication prior to the second repetition and based at least in part on the second synchronization signal.

Aspect 21: The method of any of aspects 17 through 20, further comprising: receiving, from the ambient power wireless communication device, a D2R communication based at least in part on scheduling information included in the control part.

Aspect 22: The method of any of aspects 17 through 21, wherein the second synchronization signal has a different duration than the first synchronization signal.

Aspect 23: The method of any of aspects 13 through 22, further comprising: transmitting a third synchronization signal of the R2D communication; and transmitting a third repetition of the data part based at least in part on the third synchronization signal.

Aspect 24: The method of any of aspects 13 through 23, wherein a first quantity of chips per OFDM symbol associated with the first repetition is higher than a second quantity of chips per OFDM symbol associated with the second repetition.

Aspect 25: An apparatus for wireless communication at an ambient power wireless communication device, comprising: one or more processors; and instructions stored in one or more memories and executable by the one or more processors, individually or collectively, to cause the apparatus to perform a method of any of aspects 1 through 12.

Aspect 26: An ambient power wireless communication device for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: An apparatus for wireless communication at a reader device, comprising: one or more processors; and instructions stored in one or more memories and executable by the one or more processors, individually or collectively, to cause the apparatus to perform a method of any of aspects 13 through 24.

Aspect 29: A reader device for wireless communications, comprising at least one means for performing a method of any of aspects 13 through 24.

Aspect 30: A non-transitory computer-readable medium storing code for wireless communications, the code comprising instructions executable by one or more processors to perform a method of any of aspects 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at an ambient power wireless communication device, comprising:
one or more processors; and
instructions stored in one or more memories and executable by the one or more processors, individually or collectively, to cause the apparatus to:
receive, from a reader device, a start indicator part signal of a reader to device communication, the start indicator part signal indicating a beginning of the reader to device communication and indicating for the ambient power wireless communication device to monitor for one or more data part repetitions of the reader to device communication;
receive a first synchronization signal of the reader to device communication based at least in part on the start indicator part signal;
monitor for a first repetition of a data part of the reader to device communication based at least in part on the first synchronization signal;
receive a second synchronization signal of the reader to device communication associated with a second repetition of the data part;
monitor for the second repetition of the data part based at least in part on the second synchronization signal; and
decode the data part based at least in part on monitoring for the first repetition, the second repetition, or both.

2. The apparatus of claim 1, wherein:
the first synchronization signal is a first clock acquisition part signal, and
the second synchronization signal is a second clock acquisition part signal.

3. The apparatus of claim 1, wherein:
the first synchronization signal is a first clock acquisition part signal having a first sequence type, and
the second synchronization signal is a repetition start part signal having a second sequence type different than the first sequence type.

4. The apparatus of claim 3, wherein the instructions are executable by the one or more processors, individually or collectively, to cause the apparatus to:
receive, after the second synchronization signal and prior to the second repetition, a second clock acquisition part signal having the first sequence type.

5. The apparatus of claim 1, wherein the instructions are executable by the one or more processors, individually or collectively, to cause the apparatus to:
receive a control part of the reader to device communication prior to the first repetition and based at least in part on the first synchronization signal.

6. The apparatus of claim 5, wherein:
the first synchronization signal indicates a first quantity of chips per orthogonal frequency-division multiplexing symbol associated with the control part, and
the control part indicates a second quantity of chips per orthogonal frequency-division multiplexing symbol associated with the first repetition.

7. The apparatus of claim 6, wherein the second synchronization signal indicates a third quantity of chips per orthogonal frequency-division multiplexing symbol associated with the second repetition.

8. The apparatus of claim 5, wherein the instructions are executable by the one or more processors, individually or collectively, to cause the apparatus to:
receive a second control part of the reader to device communication prior to the second repetition and based at least in part on the second synchronization signal.

9. The apparatus of claim 5, wherein the second synchronization signal has a different duration than the first synchronization signal.

10. The apparatus of claim 1, wherein the instructions are executable by the one or more processors, individually or collectively, to cause the apparatus to:
receive a third synchronization signal of the reader to device communication associated with a third repetition of the data part; and
monitor for the third repetition of the data part based at least in part on the third synchronization signal.

11. The apparatus of claim 1, wherein a first quantity of chips per orthogonal frequency-division multiplexing symbol associated with the first repetition is higher than a second quantity of chips per orthogonal frequency-division multiplexing symbol associated with the second repetition.

12. A method for wireless communications at an ambient power wireless communication device, comprising:
receiving, from a reader device, a start indicator part signal of a reader to device communication, the start indicator part signal indicating a beginning of the reader to device communication and indicating for the ambient power wireless communication device to monitor for one or more data part repetitions of the reader to device communication;
receiving a first synchronization signal of the reader to device communication based at least in part on the start indicator part signal;
monitoring for a first repetition of a data part of the reader to device communication based at least in part on the first synchronization signal;
receiving a second synchronization signal of the reader to device communication associated with a second repetition of the data part;
monitoring for the second repetition of the data part based at least in part on the second synchronization signal; and
decoding the data part based at least in part on monitoring for the first repetition, the second repetition, or both.

13. The method of claim 12, wherein:
the first synchronization signal is a first clock acquisition part signal, and
the second synchronization signal is a second clock acquisition part signal.

14. The method of claim 12, wherein:
the first synchronization signal is a first clock acquisition part signal having a first sequence type, and
the second synchronization signal is a repetition start part signal having a second sequence type different than the first sequence type.

15. The method of claim 14, further comprising:
receiving, after the second synchronization signal and prior to the second repetition, a second clock acquisition part signal having the first sequence type.

16. The method of claim 12, further comprising:
receiving a control part of the reader to device communication prior to the first repetition and based at least in part on the first synchronization signal.

17. The method of claim 16, wherein:
the first synchronization signal indicates a first quantity of chips per orthogonal frequency-division multiplexing symbol associated with the control part, and
the control part indicates a second quantity of chips per orthogonal frequency-division multiplexing symbol associated with the first repetition.

18. The method of claim 17, wherein the second synchronization signal indicates a third quantity of chips per orthogonal frequency-division multiplexing symbol associated with the second repetition.

19. The method of claim 16, further comprising:
receiving a second control part of the reader to device communication prior to the second repetition and based at least in part on the second synchronization signal.

20. A non-transitory computer-readable medium storing code for wireless communications at an ambient power wireless communication device, the code comprising instructions executable by one or more processors to:
receive, from a reader device, a start indicator part signal of a reader to device communication, the start indicator part signal indicating a beginning of the reader to device communication and indicating for the ambient power wireless communication device to monitor for one or more data part repetitions of the reader to device communication;
receive a first synchronization signal of the reader to device communication based at least in part on the start indicator part signal;
monitor for a first repetition of a data part of the reader to device communication based at least in part on the first synchronization signal;
receive a second synchronization signal of the reader to device communication associated with a second repetition of the data part;
monitor for the second repetition of the data part based at least in part on the second synchronization signal; and
decode the data part based at least in part on monitoring for the first repetition, the second repetition, or both.
